(19) United States
(12) Patent Application Publication
(10) Pub. No.: US 2008/0192623 A1
(43) Pub. Date: Aug. 14, 2008

(54) METHODS AND DEVICES FOR DUAL-TONE MULTI-FREQUENCY (DTMF) SIGNALING

(75) Inventor: Ching Sheng Chen, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/673,114

(22) Filed: Feb. 9, 2007

(51) Int. Cl. H04J 3/14

(52) U.S. Cl. 370/212

(57) ABSTRACT

A method for dual-tone multi-frequency (DTMF) signaling is implemented in a communication device and comprises the following steps. Transmission of a DTMF event of a digit is triggered if a button-down event occurs. A packet carrying the DTMF event with assigned non-zero event duration is generated regardless of the currently-detected duration of the button-down event. The packet is transmitted over a communication channel.

### BACKGROUND OF THE INVENTION

1. Field of the Invention

The invention relates to communication techniques, and more particularly to methods and devices for dual-tone multi-frequency (DTMF) signaling.

2. Description of the Related Art

Dual-tone multi-frequency (DTMF) signals are audio signals that are generated when any button on a touch-tone telephone is pressed. In some cases, DTMF is utilized for sending control signals along a telephone line. DTMF detection with satisfactory precision, however, is difficult. Some conventional solutions are illustrated below.

Voice over Internet Protocol (VoIP) allows users to make telephone calls over a computer network such as the Internet. As Internet phones and VoIP applications become increasingly more popular, various codecs, such as G.723.1 or G.729, are used for voice encoding and decoding to minimize the volume of data transmission over the Internet. Some of these codes provide acceptable voice quality, but make in-band signals, such as DTMF, unrecognizable to communication devices. Some solutions, such as RFC 2833 and U.S. Pat. No. 6,771,641, are proposed to send DTMF events as out-of-band signals. Other patents, such as U.S. Pat. Nos. 6,259,691, 6,456,618, and 6,385,192 have also been proposed to solve this issue.

In the “RTP trunk” application, realtime transport protocol (RTP) is used to replace a normal circuit-switched trunk between two nodes. This is of particularly interest in telephone networks (such as the public switched telephone network, PSTN) that are still mostly circuit-switched. In this case, DTMF events are carried by RTP packets without guarantee of reliable delivery, but DTMF event transmission is required to be reliable to a certain level to avoid control errors, such as errors in contact with an interactive voice-response (IVR) system. DTMF digit retransmission is suggested in RFC 2833. The audio redundancy mechanism (RFC 2198) is mentioned in RFC 2833 as an option for DTMF packet retransmission, but the mechanism can cause DTMF transmission delays.

FIG. 1 shows an example of DTMF packet retransmission performed by a conventional DTMF packet transmission device. As shown in FIG. 1, a series of DTMF digits “9”, “1”, and “1” are sequentially inputted respectively at times T₁, T₂, and T₃. The device then collects the inputted DTMF digits, but waits until time T₅ to send out a predetermined number of duplicated DTMF packets, each carrying information of the full series “911”. However, as shown in FIG. 1, even though the input of those DTMF digits is completed early at time T₄, the conventional DTMF packet transmission device has to wait until the time T₅ to send out those inputted DTMF digits in the conventional DTMF packet transmission process. This may cause a serious DTMF transmission delay.

### BRIEF SUMMARY OF THE INVENTION

A detailed description is given in the following embodiments with reference to the accompanying drawings.

An exemplary embodiment of a method for dual-tone multi-frequency (DTMF) signaling is implemented in a communication device and comprises the following steps. Transmission of a DTMF event of a digit is triggered if a button-down event occurs. A packet carrying the DTMF event with assigned non-zero event duration is generated regardless of the currently-detected duration of the button-down event. The packet is transmitted over a communication channel.

An exemplary embodiment of a communication device capable of dual-tone multi-frequency (DTMF) signaling comprises a processor and a communication unit. Upon receiving a button-down event for triggering transmission of a DTMF event of a digit, the processor generates a packet carrying the DTMF event with assigned event duration thereof with a non-zero value regardless of the currently-detected duration of the button-down event. The communication unit transmits the packet over a communication channel.

An exemplary embodiment of a method for dual-tone multi-frequency (DTMF) signaling is implemented in a communication device and comprises the following steps. A button-down event for triggering transmission of a DTMF event of a digit is received. A first packet carrying the DTMF event is generated and transmitted over a communication channel as soon as possible such that the interval between the start time of the button-down event and the transmission time of the first packet is less than the interval between the transmission time of the first packet and a subsequent packet of the DTMF event.

### BRIEF DESCRIPTION OF THE DRAWINGS

The invention can be more fully understood by reading the subsequent detailed description and examples with references made to the accompanying drawings, wherein:

FIG. 1 is a schematic diagram of an example of the DTMF packet retransmission;

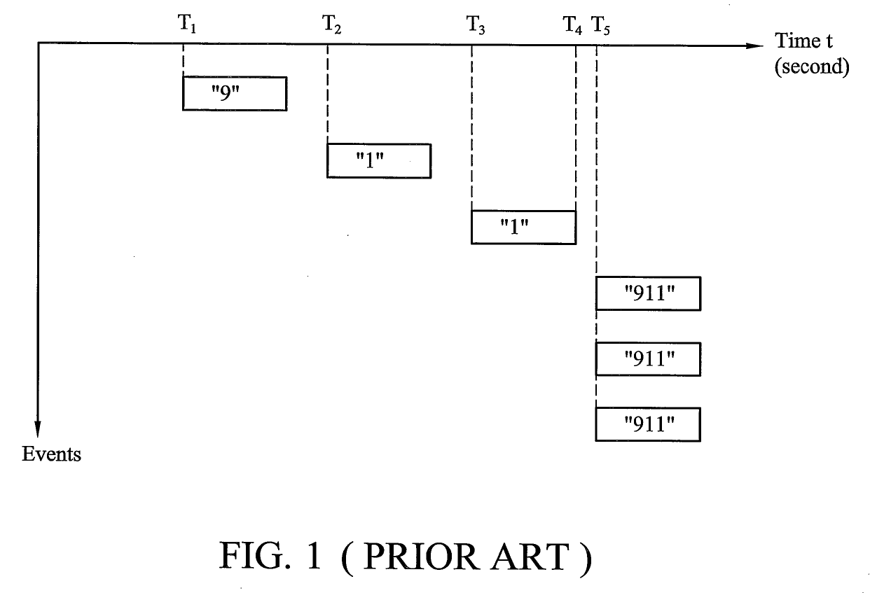

FIG. 2 is a block diagram of the configuration of an exemplary embodiment of a communication device and a network system;

FIG. 3 is a block diagram of the configuration of another exemplary embodiment of a communication device;

FIG. 4 is a schematic view showing a exemplary payload format for DTMF events;

FIG. 5 shows an example of packet transmission in a DTMF event;

FIG. 6 shows another example of packet transmission in a DTMF event;

FIG. 7 is flowchart of initiating a DTMF event;

FIG. 8 is flowchart of terminating a DTMF event;

FIG. 9 is an example of DTMF event transmission;

FIG. 10 is second example of DTMF event transmission;

FIG. 11 is third example of DTMF event transmission; and

FIG. 12 is fourth example of DTMF event transmission.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Methods and devices for DTMF signaling are provided with exemplary embodiments thereof organized as:

1. Data format;

2. Hardware configuration;

3. DTMF signaling methods;

4. DTMF event receiver; and

5. Some variations.

1. Data Format

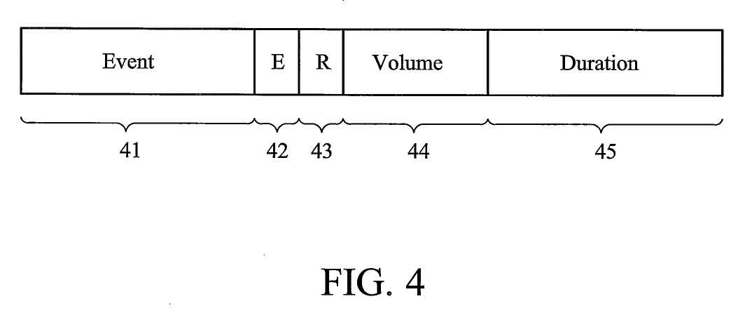

DTMF events and associated information such as DTMF digits, tone volume, event duration are carried by packets, such as realtime transport protocol (RTP) packets or packets in another protocol format not yet developed. DTMF digit and event duration may be transmitted through in-band signaling. Namely, DTMF digits and named telephone events may be carried as part of the audio stream, and use the same sequence number and time-stamp base as the regular audio channel to simplify the generation of audio waveforms at a gateway. Each RTP packet comprises the RTP header and the RTP payload. The RTP header provides a timestamp field that corresponds to the time of creation of the DTMF digit. Payload Format for DTMF Events compatible with payload format disclosed in the standard RFC 2833 is shown in FIG. 4.

In DTMF packet transmission process, DTMF digit may be the number or symbol a user dials on the telephone, which needs to be further encoded. As shown in FIG. 4, code field 41 stores an encoded DTMF digit which is encoded in the format shown in Table 1 compatible with RFC 2833.

TABLE 1

| Digit | Encoded digit (decimal) |
|---|---|
| 0~9 | 0~9 |
| * | 10 |
| # | 11 |
| A~D | 12~15 |
| Flash | 16 |

In FIG. 4, E field 42 serves as the “end” bit, if set to a specific value, such as one, indicates that this packet is the end of the DTMF event. The duration parameter in field 45 of the packet of the end of the event measures the complete duration of the event. A sender may delay setting the end bit until retransmitting the last duplicated packet for a tone, rather than on its first transmission. This avoids having to wait to detect whether the tone has actually ended. In conclusion, a packet carrying the event with an asserted “end” bit is the last packet of the event.

In FIG. 4, R field 43 may be reserved for future use. A sender may set it to zero, and the receiver may ignore it.

In FIG. 4, Volume field 44 describes the power level of the tone, which may be expressed in dBm0 after dropping the sign. Power levels may range from 0 to −63 dBm0. The range of valid DTMF is from 0 to −36 dBm0; lower than −55 dBm0 must be rejected. Thus, larger values denote lower volume. This value may be set to zero by the packet sender and is ignored by the receiver.

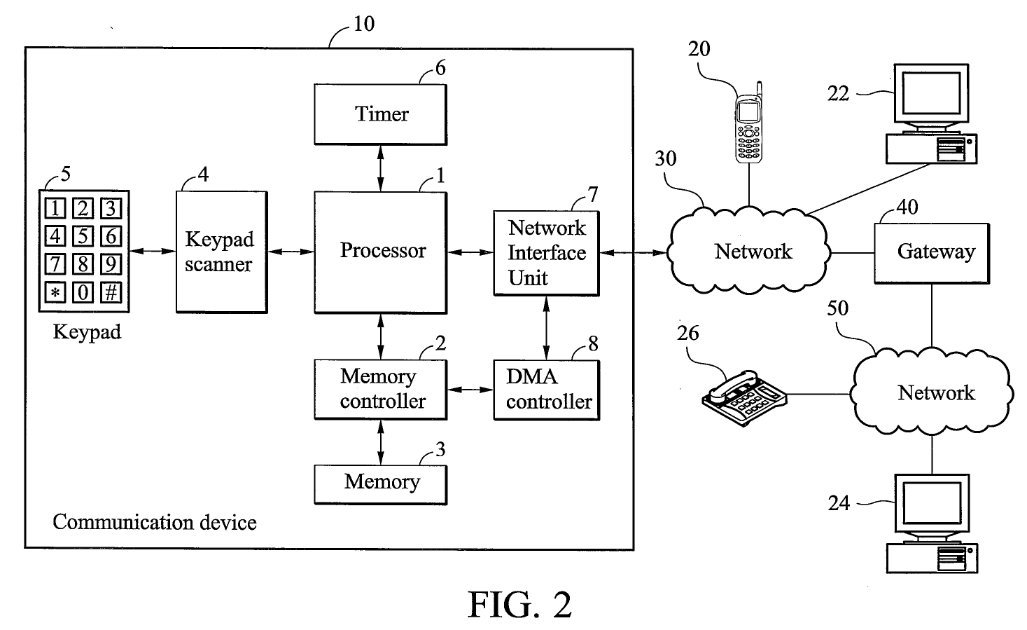

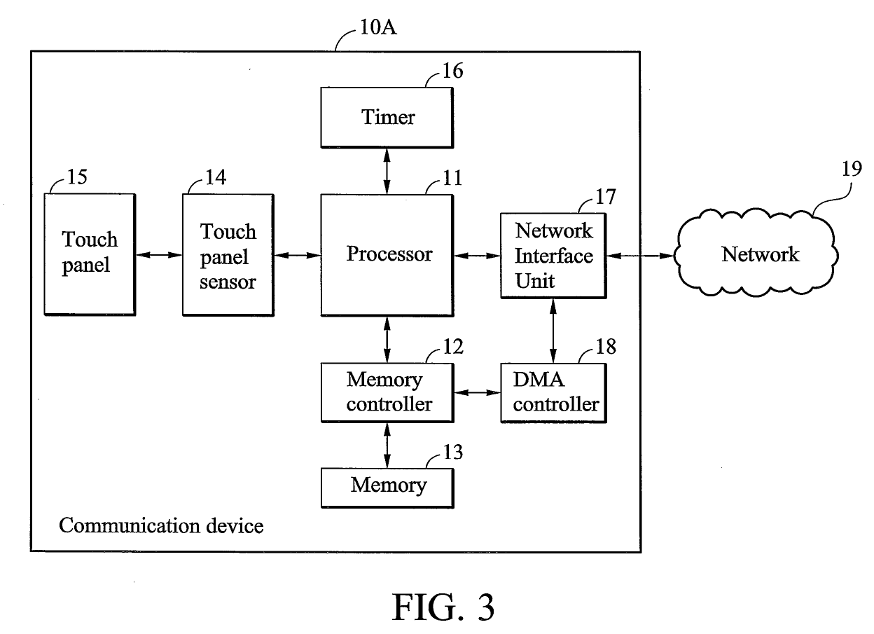

In FIG. 4, Duration field 45 describes duration of this event, for example, in timestamp units. A receiver may utilize the field to tell when the event began using the time instant identified by a timestamp, such as the RTP timestamp stored in a RTP header, and has so far lasted as long as indicated by this parameter. Timer 6 in FIG. 2 (or timer 16 in FIG. 3) may provide the timestamp for each event. Please note that this field does not indicate the end of the event.

The above-mentioned payload format may be modified, and some of the fields may be omitted, such as fields 42˜44. When volume field 44 is removed from the payload format, DTMF tones may be reproduced in a default volume.

2. Hardware Configuration

With reference to FIG. 2, Communication device 10 is coupled to a network system in which several devices are coupled with the networks. Network 30 and network 50 may comprise a local area network (LAN) or a wide area network (WAN), such as the Internet or the PSTN. The communication device 10 is connected to other communication devices, such as the mobile device 20, computer 22 through network 30, or computer 24 through gateway 40 and network 50. Mobile device 20 may comprise a mobile phone, a personal digital assistant (PDA), a tablet personal computer (PC), or a similar portable device. Computers 22 and 24 may comprise desktop computers, laptop computers, tablet computers, or mobile devices. Gateway 40, also connected to network 30, routes packets between network 30 and another network, network 50. Telephone 26 may be a traditional telephone.

In communication device 10, processor 1 controls the operation of the whole system as it fetches and executes software codes stored in memory 3. Memory controller 2 serves as the bridge between processor 1 and memory 3 to transfer data therebetween. Keypad scanner 4 detects the key press and key release activities of keypad 5, which contains an array of keys for which DTMF key press and release network data packets can be generated. Whenever a key on Keypad 5 is pressed, Keypad Scanner 4 detects it and sends a button-down event to processor 1, which will generate the network packet data representative of the DTMF event associated with the pressed key. Similarly, processor 1 will generate another packet representative of a released key when keypad scanner 4 detects the key has been released and sends a button-up event to processor 1. Timer 6 provides timing information to processor 1, so that processor 1 can determine the time interval between certain events, such as how long a key was pressed before being released. Timer 6 can also notify processor 1 at a predetermined time, so that processor 1 can know when to start a certain operation, such as sending a network data packet some time after a previous one was sent. Timer 6 may comprise a plurality of timing devices, such as a clock reporting current time and a timer triggering event or operation.

Network Interface Unit (NIU) 7, the communication unit of device 10, connects with Network 30 via certain network protocol, such as TCP/IP. Common NIUs include Ethernet network interface devices and IEEE 802.11 wireless local area network (WLAN) devices. The connection with Network 30 can be wired or wireless, depending on the NIU technology employed. Additionally, when the DTMF signaling method is embodied in a mobile phone, the NIU can be a cellular MODEM unit, such as a GSM/GPRS or W-CDMA communication module, which communicates with the cellular network in compliance with the GSM/GPRS or W-CDMA standards.

NIU 7 transfers and receives packets to and from Network 30. Data packets outgoing to Network 30 may be prepared and provided by processor 1, or preferably by DMA controller 8 which obtains packet data from memory 3 through memory controller 2 without intervention of processor 1.

When communication device 10 is going to send a packet to network 30, processor 1 composes the packet in memory 3, and then programs DMA controller 8 to transfer the packet through NIU 7 to network 30. In the opposite direction, when a packet is received from Network 30, the packet can go through NIU 7, DMA controller 8 and memory controller 2 to memory 3. Processor 1 may then access the packet data in memory 3 to perform necessary operations.

Communication device 10 capable of DTMF signaling may comprise a mobile device (such as a cell phone or a PDA), a VoIP phone, a laptop or desktop computer, or other devices. Note that DTMF events may be managed by other processors, such as memory controller 2, DMA controller 8, or a processor in NIU 7. In some embodiments of the communication device, two components (such as processor 1, memory controller 2, memory 3, or DMA controller 8) may be integrated into a single chip. Communication device 10 may comprise more input devices, such as a touch panel, a touch screen, or a voice control device converting voice signals into digits. Button-down and button-up events may be generated by any of these input devices and accordingly issue DTMF events.

With reference to FIG. 3, communication device 10A is another embodiment of a DTMF processing device, in which touch panel 15 and touch panel sensor 14 are employed. Virtual keys representing a keypad may be presented on touch panel 15. Touch panel sensor 14 detects pressing of a virtual key (such as a key of number 0˜9, “*”, and “#”) on touch panel 15 and sends a button-down event to processor 11, which triggers a DTMF event associated with the pressed key and a packet carrying the DTMF event to be generated. Touch panel sensor 14 detects release of the virtual key and sends a button-up event to processor 11, which triggers generation of a packet indicating the end of the DTMF event. Each entity in FIG. 2 may be a sender or a receiver of DTMF events.

It is possible to use different algorithms to create tones from the encoded DTMF digits. A receiver may simply place a tone of a given duration in an audio playout buffer at the location indicated by the timestamp. As additional packets are received that extend the same tone, the waveform in the playout buffer is extended accordingly. Thus, if a packet in a tone gets lost and the playout delay is short, a gap in the tone may occur. The error resiliency depends on the playout delay at the receiver, which is according to the event duration in duration field 45 of received packets. Two examples with DTMF event transmission delay are given in this section in the following for comparison with improved methods described in section 3, the “DTMF signaling methods”.

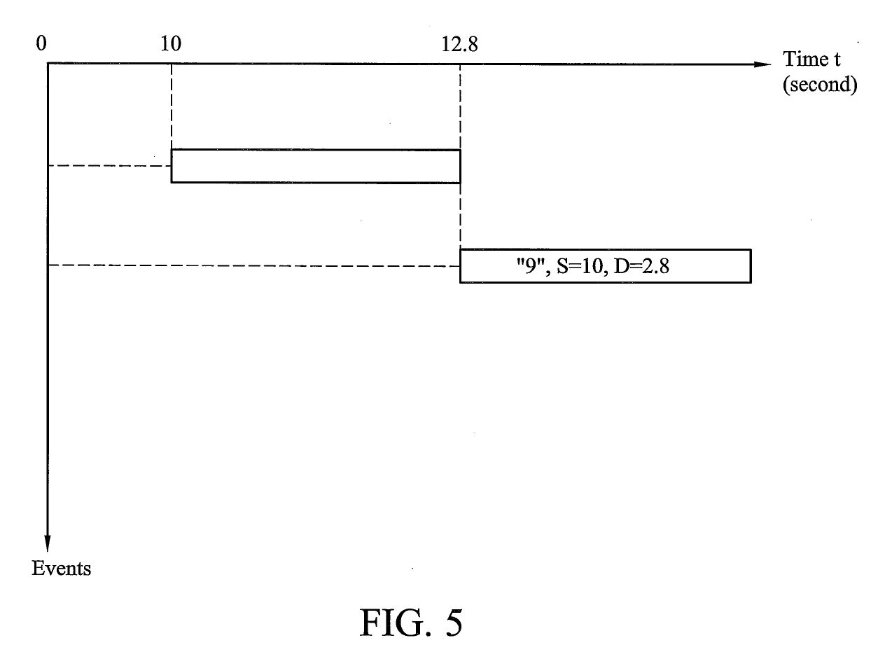

FIG. 5 is an example of packet transmission of a DTMF event according to the related art. A sender with key of number “9” pressed for 2.8 seconds (from second 10 to second 12.8) sends a packet with DTMF digit “9”, timestamp=10 (denoted as “S=10” in FIG. 5), duration=2.8 (denoted as “D=2.8” in FIG. 5). At release of the key, the event completes, and the last packet is sent indicating the real duration of the DTMF event. Since some tones are many seconds long, a substantial delay to packet transmission is incurred after the key press and postponing packet arrival at the receiver.

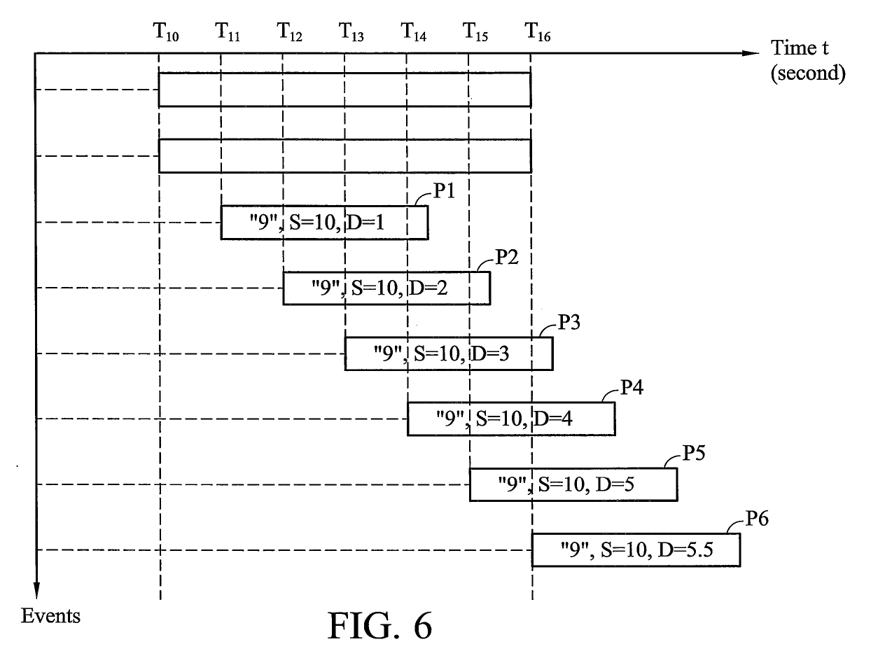

FIG. 6 is an example of typical packet transmission of a DTMF event, where DTMF digits and events are sent incrementally to avoid having the receiver wait for the completion of the event. The key of number “9” is pressed from T₁₀ (t=10) to T₁₆ (t=15.5), totally 5.5 seconds (It is pressed at time T₁₀ and is released at T₁₆). Each of packets P1˜P6 respectively sent at T₁₁ to T₁₆ for a DTMF event “9” are sent subsequently for each one-second interval following the press of the key. The interval between two successive packet transmissions is referred to as a packet interval. Packet P1 is composed and sent out one second (the duration between T₁₀ and T₁₁) after a button-down event generated by the press of the key. Packet P1 comprises DTMF digit “9”, timestamp=10, and duration=1. Packet P2 is composed and sent out one second after delivery of packet P1. Packet P2 comprises DTMF digit “9”, timestamp=10, and duration=2. The value of the timestamp in packets P2˜P6 remains the same as that of packet P1 denoting the start time of the DTMF event. The duration parameter in each packet records currently measured event duration of the DTMF event. Thus, each duration parameter is one second greater than that of its previous packet. It should be noted that the one second duration between each packet is not limited in the present invention. It may be configurable. Packet P6 is the last packet of the DTMF event “9” and thus comprises the actual and final duration of the event, which is “5.5”. However, in this example, a one-second delay (between T₁₀ and T₁₁) for transmitting the first packet P1 still exists.

3. DTMF Signaling Methods

An exemplary embodiment of the method for dual-tone multi-frequency (DTMF) signaling may be implemented in communication device 10, 10A, or other entities in FIG. 2.

When receiving a button-down event for triggering a DTMF event and transmission of a DTMF digit, processor 1 generates and transmits a first packet carrying the DTMF digit through NIU7 as soon as the interval between the transmission time of the first packet and the start time of the button-down event is less than the interval between the transmission time of the first packet and a subsequent packet of the DTMF event, carrying the same DTMF digit and timestamp as those of the first packet. The first packet with an empty code field 41 may be composed and stored in a buffer in advance. Processor 1 may wait for a button-down event to populate the empty code field 41 with a corresponding DTMF event and transmits the pre-composed packet via NIU 7, to thus reduce the interval between the start time of the button-down event and the transmission time of the first packet. The first packet with an empty code field 41 may be encapsulated with necessary header in advance and stored in memory 3, NIU 7, or any other location in communication device 10.

A first timer in timer 6 is initialized to zero, and, when set to start, increases to measure event duration. A second timer in timer 6 is utilized to signify the end of each packet interval. Note that the second timer may or may not be a countdown timer, e.g. a timer increasing from zero to a predetermined amount of time. The second timer may be utilized to control packet intervals to be the same or have various lengths. Note that different timers may be utilized to control the lengths of different packet intervals.

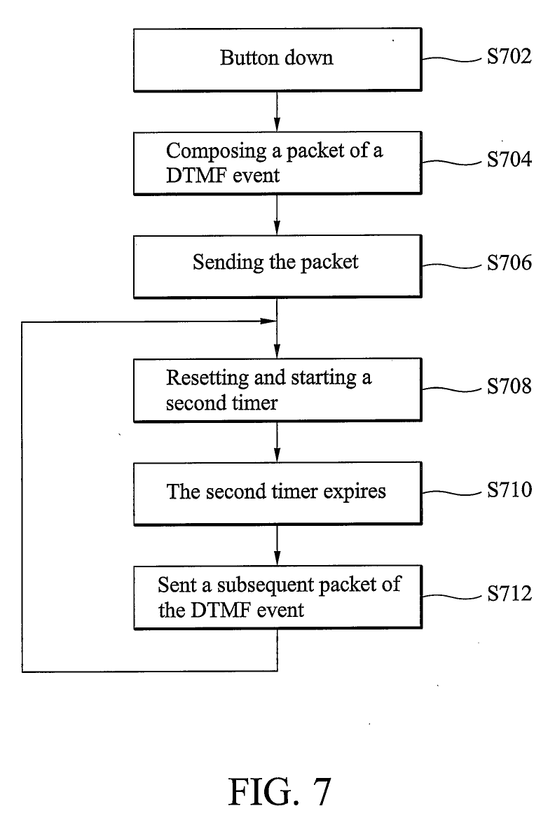

With reference to FIG. 7, a button-down event corresponding to a digit is generated by an input device for triggering a DTMF event of the digit (step S702). Upon receiving the button-down event, processor 11 generates a first packet of the DTMF event carrying the DTMF digit with assigned non-zero event duration thereof regardless of the current duration of the button-down event (step S704). Processor 1 may retrieve the start time of the button-down event from a clock of timer 6, utilize the start time as the timestamp of the DTMF event, and record the timestamp in the first packet. Alternatively, timestamp of the DTMF event may be the time when composing the first packet is completed. The value of the event duration in the first packet may be a predetermined constant duration stored in communication device 10 prior to the button-down event. Alternatively, the value of the event duration may be derived from a predetermined variable x plus the currently-detected duration of the button-down event, wherein the predetermined variable x may be also stored in communication device 10 prior to the button-down event. Processor 1 may start the first timer as soon as the button-down event occurs. If the first timer starts at the same time as the button-down event, the value of the event duration may be derived from x+t0, wherein to is the value of the first timer. According to FIG. 7, the first timer is not started until the first packet is sent, so the value of the event duration may be derived from x+0, wherein 0 is the current value of the timer. The predetermined value x or the constant duration may be adjustable, and communication device 10 may provide a user interface to adjust the x or the constant duration. The predetermined variable x may preferably lie in a range, such as, from one to ten seconds.

Processor 1 directs NIU 7 to transmit the first packet over a communication channel to a receiver (step S706). Preferably, processor 1 generates and sends the first packet in real time as soon as the button-down event occurs. After transmitting the first packet, processor 1 starts the first timer and the second timer (step S708), and, when the second timer expires (step S710), transmits another packet of the DTMF event (step S712). Before the button-down is terminated by a button-up event, steps S708, S710, and S712 are repeated to transmit multiple packets of the DTMF event. Packets of an identical DTMF event can be identified based on the DTMF digit and timestamp in each packet.

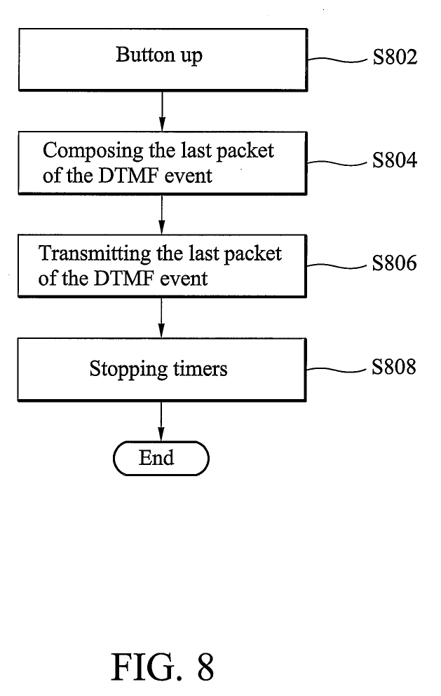

With reference to FIG. 8, when receiving a button-up event signifying the end of the button-down event (step S802), processor 1 composes and transmits the last packet of the DTMF event (steps S804 and S806), and stops the first and second timers (step S808). In step S804, processor 1 retrieves the real event duration of the DTMF event from the first timer as the event duration in the last packet. In step S806, processor 1 may send multiple redundant last packets of the DTMF event. The number of the redundant last packets for each DTMF event may be adjustable through a user interface of communication device 10.

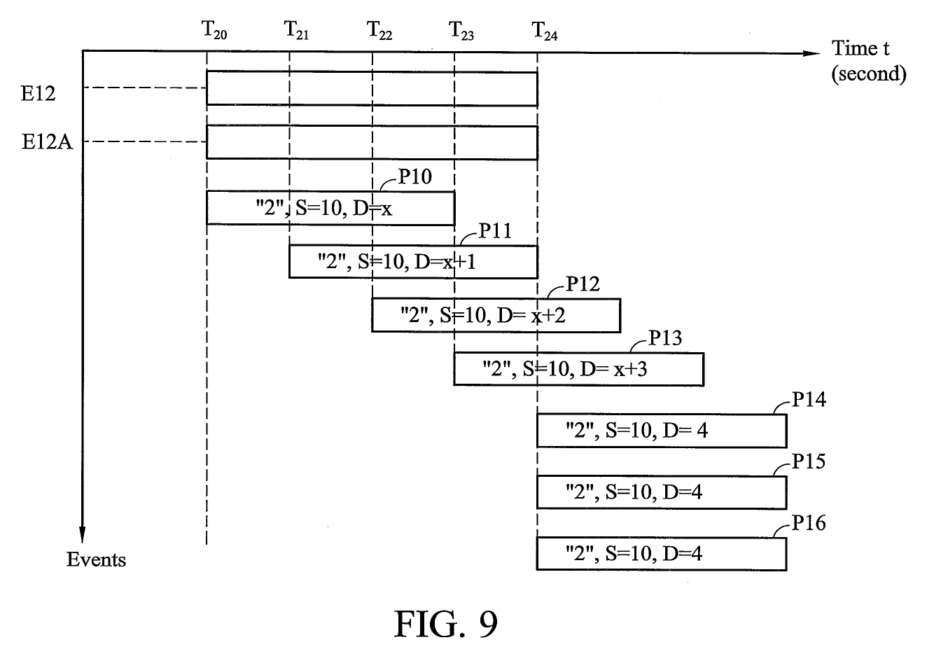

With reference to FIG. 9, an example of DTMF event transmission according to the method is provided. Button-down event E12 represents press of the key of number “2” which lasts from T₂₀ (t=second 10) to T₂₄ (t=second 14), totally 4 seconds, and triggers DTMF event E12A. Upon receiving button-down event E12 (step S702), processor 11 generates a first packet P10 of the DTMF event of “2” with an assigned non-zero event duration x (denoted as D=x) (step S704) and sends packet P10 as soon as the key is pressed at T₂₀ (step S706). After transmitting the first packet P10, processor 1 starts the first timer and the second timer (step S708), and, when the second timer expires (step S710), transmits packet P11 of the DTMF event (step S712). Packet P11 is composed and is sent out one second after a button-down event generated by the press of the key. The event duration in Packet P11 (denoted as D in FIG. 9) may be derived from x+1 (denoted as D=x+1), wherein “1” is the current value of the second timer, and x is preset as a positive number. The event duration packet P11 is greater than the currently-detected duration of button-down event E12. Processor 1 transmits more packets of the DTMF event after each packet interval following the transmission of the first packet P10 before the end of the button-down event. Packets P11˜P13 with duration x+1, x+2, and x+3 are respectively sent at T₂₁, T₂₂, and T₂₃ for a DTMF event “2”. T₂₁ to T₂₃ are respectively located the end of each packet interval following the press of the key. Variable x may be preset to one second or more. Note that variable x may be at least greater than the packet interval kept by the second timer and preferably great enough to prevent any tone playout gap. Preferably, x could be between 0 to 10. Alternatively, the duration parameters in these packets may record a constant duration, or the currently measured event duration of the DTMF event reported by the first timer.

At the end of the button-down event E12, i.e. T₂₄, processor 1 composes and transmits the last packet of the DTMF event to notify the receiver of the end of the DTMF event. Packet P14 is the last packet of the DTMF event “9” and thus comprises the actual and final duration of the event, which is “4”. Processor 1 may send multiple redundant last packets P15 and P16 of the DTMF event. In FIG. 9, no delay except for the time necessary for packet generation and processing is incurred in transmitting the first packet P10. Redundant instances of the last packet are sent to prevent packet loss and arbitrary tone playout extension.

4. DTMF Event Receiver

A receiver, for example, gateway 40, utilizes a third timer to keep output duration of a DTMF tone consistent with the event duration in the last received packet of the DTMF event from which the DTMF tone is reproduced. Event duration in the newest packet of the DTMF event received by the receiver may be stored in a buffer, thus to dynamically update the value in the buffer. The third timer may start and automatically increase when the first packet of the DTMF event is received, thus to measure DTMF tone playout of the DTMF event. When the third timer reaches or exceeds the value stored in the buffer, the receiver stops the DTMF tone. Thus, when receiving the last packet of the DTMF event with the actual event duration thereof, the receiver may accordingly and timely stops the DTMF tone. The receiver also stops the tone of a DTMF event when receiving a new DTMF event without any last packet of the former event. After receiving a last packet of a DTMF event, the receiver discards redundant instances of the last packet.

5. Some Variations

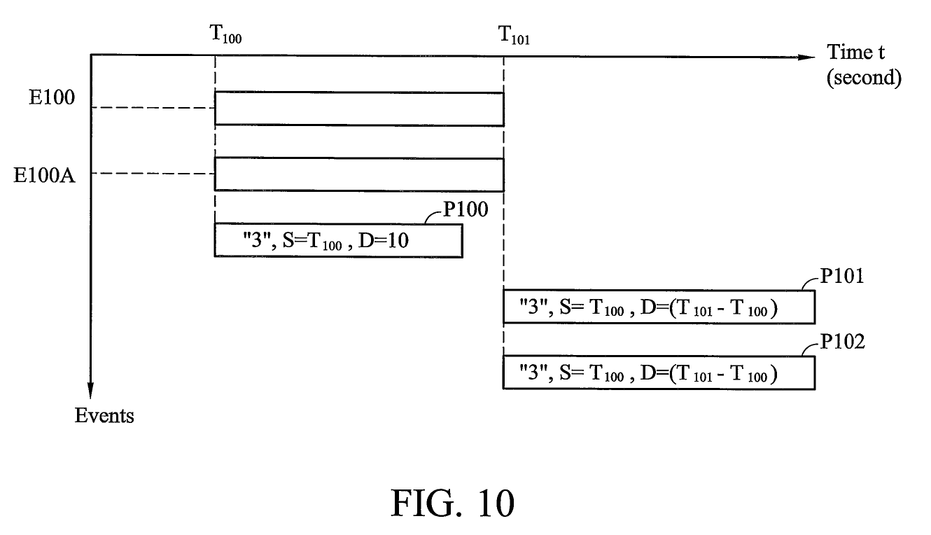

The variable x may be the predetermined event duration of a DTMF event carried by the first packet thereof, so variable x may be not less than the duration of the packet interval. If variable x or said constant event duration is great enough, e.g. 10 seconds, processor 1 may send only one or more the last packets of a DTMF event following the first packet thereof at the end of the event, as shown in FIG. 10. With reference to FIG. 10, button-down event E100 begins at T₁₀₀ and ends at T₁₀₁ and triggers a DTMF event E100A. Processor 1 generates and sends the first packet P100 of the DTMF event of “3” with an assigned event duration “10” at T₁₀₀, but does not start the second timer nor send more packets of the DTMF event before the end thereof. When detecting the end of the DTMF event, processor 1 sends two instances (i.e. packet P101 and P102) of the last packet of the DTMF event at T₁₀₁.

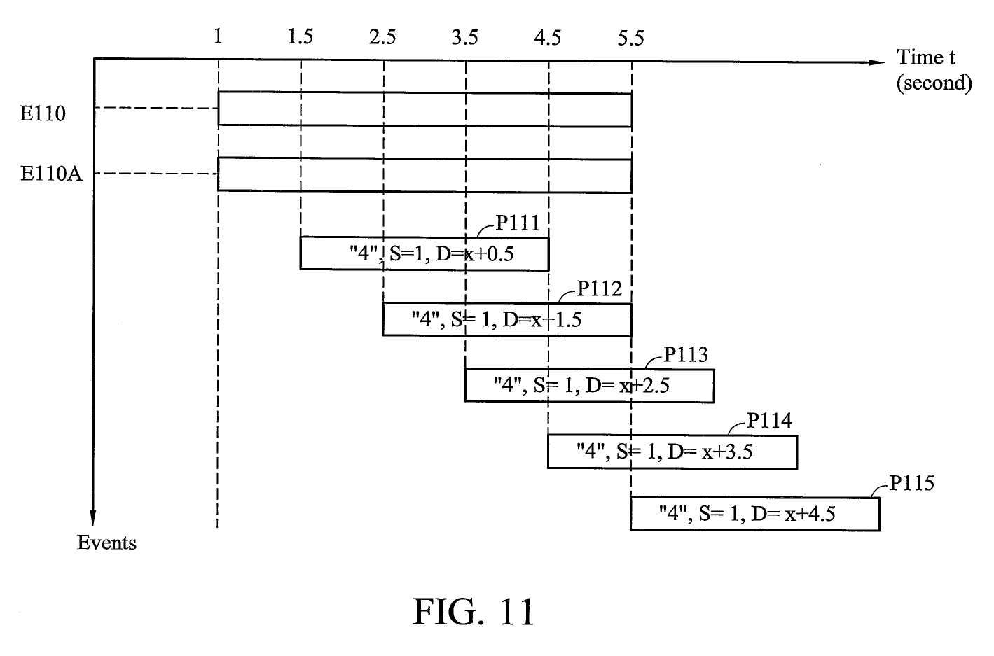

The first packet of a DTMF event may be composed after occurrence of a corresponding button-event. In this case, limited delay of transmission of the first packet of a DTMF event may be allowed. With reference to FIG. 11, button-down event E110 begins at t=1 and ends at t=5.5 and triggers a DTMF event E110A. Processor 1 generates and sends the first packet P11 of the DTMF event “4” with an assigned event duration “x+0.5” at t=1.5. The interval between the beginning of event E110 and transmission of packet P11 is less than the packet interval between any two packets of the DTMF event. Duration “x+0.5” in packet P11, however, is required to be greater than the packet interval.

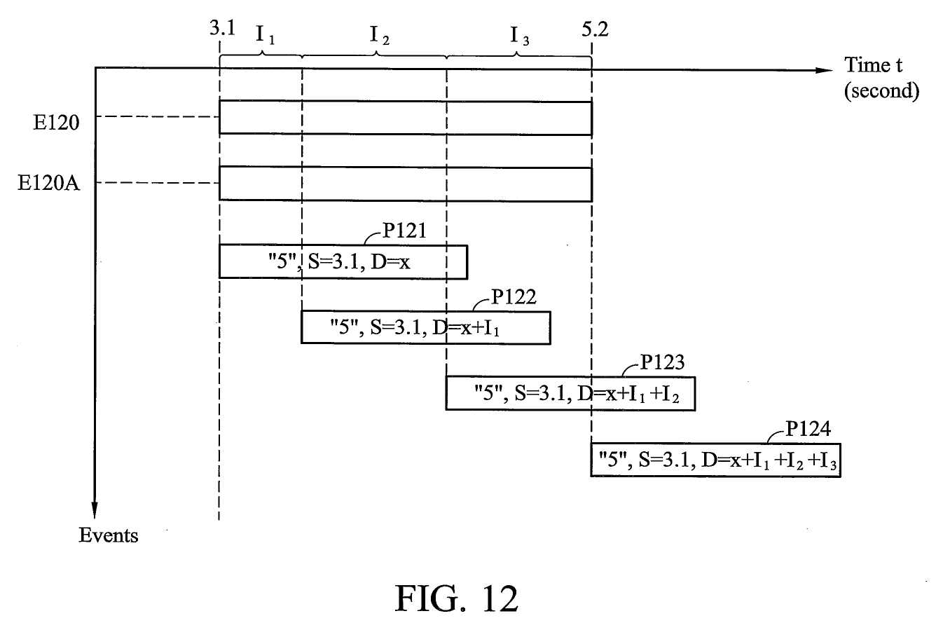

A DTMF event may be provided with different packet intervals. With reference to FIG. 12, button-down event E120 begins at t=3.1 and ends at t=5.2 and triggers a DTMF event E120A. Processor 1 generates and sends the first packet P121 of the DTMF event of “5” with an assigned event duration “x” at t=3.1. I₁, I₂, and I₃ are respectively the packet intervals between packets P121 and P122, P122 and P123, P123 and P124. I₁, I₂, and I₃ are time instances of different length. Variable x is preferably not less than the maximum among I₁, I₂, and I₃. Communication device 10 may provide a user interface to configure the pattern of (I₁, I₂, I₃).

The proposed methods adopt an interleaving retransmission mechanism, which actually sends DTMF packets out at the moment a user presses a key for a DTMF event, continues to send packets of the DTMF event with sliding transmission time while the user continues to press the key, and sends a DTMF packet with actual event duration to terminate this event when a user releases the key. Event duration in the first packet of the DTMF event is properly assigned regardless of actual duration of the DTMF event.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for dual-tone multi-frequency (DTMF) signaling, implemented in a communication device, comprising:
receiving data of a DTMF digit to start a DTMF event;
providing a predefined dummy time;
generating a first packet of the DTMF event, wherein the first packet records the data of the DTMF digit, a duration of the DTMF event, and a transmission time of the first packet, wherein the predefined dummy time is less than the duration of the DTMF event, and the transmission time of the first packet comprises at least the predefined dummy time; and
transmitting the first packet of the DTMF event at the transmission time of the first packet.

2. The method as claimed in claim 1, further comprising:
generating a second packet of the DTMF event after the transmission of the first packet of the DTMF event, wherein the second packet records the data of the DTMF digit, a duration of the DTMF event, and a transmission time of the second packet, wherein the transmission time of the second packet equals to the transmission time of the first packet plus a time offset; and
transmitting the second packet of the DTMF event at the transmission time of the second packet.

3. The method as claimed in claim 1, further comprising:
generating a third packet of the DTMF event, wherein the third packet records the data of the DTMF digit, a duration of the DTMF event, and a transmission time of the third packet, wherein the transmission time of the third packet equals to the duration of the DTMF event; and
transmitting the third packet of the DTMF event at the transmission time of the third packet, wherein the third packet of the DTMF event is repeatedly transmitted for a predetermined number of times.

4. The method as claimed in claim 1, further comprising:
performing a button-down event to trigger the DTMF event, wherein the transmission time of the first packet is equal to the predefined dummy time plus a duration of the button-down event.

5. The method as claimed in claim 1, wherein the predefined dummy time is within a range from one to ten seconds.

6. The method as claimed in claim 1, wherein the first packet is a realtime transport protocol (RTP) packet.

7. The method as claimed in claim 1, wherein the communication device comprises a phone device.

8. A communication device, capable of dual-tone multi-frequency (DTMF) signaling, comprising:
a DTMF receiver, receiving data of a DTMF digit to start a DTMF event;
a DTMF controller, coupled to the DTMF receiver, providing a predefined dummy time and generating a first packet of the DTMF event, wherein the first packet records the data of the DTMF digit, a duration of the DTMF event, and a transmission time of the first packet, wherein the predefined dummy time is less than the duration of the DTMF event, and the transmission time of the first packet comprises at least the predefined dummy time; and
a communication unit, coupled to the DTMF controller, for transmitting the first packet of the DTMF event at the transmission time of the first packet.

9. The communication device as claimed in claim 8, wherein the DTMF controller further generates a second packet of the DTMF event after the transmission of the first packet of the DTMF event, wherein the second packet records the data of the DTMF digit, a duration of the DTMF event, and a transmission time of the second packet, wherein the transmission time of the second packet equals to the transmission time of the first packet plus a time offset; and the communication unit further transmits the second packet of the DTMF event at the transmission time of the second packet.

10. The communication device as claimed in claim 8, wherein the DTMF controller further generates a third packet of the DTMF event, wherein the third packet records the data of the DTMF digit, a duration of the DTMF event, and a transmission time of the third packet, wherein the transmission time of the third packet equals to the duration of the DTMF event; and the communication unit further transmits the third packet of the DTMF event at the transmission time of the third packet, wherein the third packet of the DTMF event is repeatedly transmitted for a predetermined number of times.

11. The communication device as claimed in claim 8, wherein the receiver further comprising:
a trigger device for performing a button-down event to trigger the DTMF event, wherein the transmission time of the first packet is equal to the predefined dummy time plus a duration of the button-down event.

12. The communication device as claimed in claim 11, wherein the trigger device further comprising:
a mechanical button; and
a means for detecting a button press activity of the mechanical button to send the button-down event to the controller.

13. The communication device as claimed in claim 11, wherein the trigger device further comprising:
a virtual button; and
a touch pad for detecting a button press activity of the virtual button to send the button-down event to the processor.

14. The communication device as claimed in claim 8, wherein the predefined dummy time is within a range from one to ten seconds.

15. The communication device as claimed in claim 8, wherein the first packet is a realtime transport protocol (RTP) packet.

16. The communication device as claimed in claim 8, wherein the communication device comprises a cell phone, a personal digital assistant (PDA), or a VoIP phone.
